(19) United States
(12) Patent Application Publication
(10) Pub. No.: US 2018/0203238 A1
(43) Pub. Date: Jul. 19, 2018

(54) METHOD OF EDUCATION AND SIMULATION LEARNING

(71) Applicant: Marshall Leroy Smith, JR., Phoenix, AZ (US)

(72) Inventor: Marshall Leroy Smith, JR., Phoenix, AZ (US)

(21) Appl. No.: 15/820,366

(22) Filed: Nov. 21, 2017

Related U.S. Application Data
(60) Provisional application No. 62/447,564, filed on Jan. 18, 2017.

(51) Int. Cl. G02B 27/01; G06T 19/00; G09B 5/06; G09B 9/00

(52) U.S. Cl. CPC G02B 27/0172; G06T 19/006; G02B 2027/0178; G09B 9/00; G09B 5/06

(57) ABSTRACT

This application describes a unique teaching and learning methodology created by the merger and integration of both well accepted and emerging technologies in an effort to improve adult education. This proposed model incorporates the transfer of the simulation learning experience from the current physical platform onto a virtual platform, and then integrates that with the new technologies of augmented reality, natural language processing, and artificial intelligence.

### CROSS-REFERENCE TO RELATED APPLICATIONS

This application claims priority to U.S. Patent Appl. Ser. No. 62/447,564, filed Jan. 18, 2017, entitled “Method of Education and Simulation Learning.” The foregoing patent application is hereby incorporated herein by reference in its entirety for all purposes.

### STATEMENT OF FEDERALLY SPONSORED RESEARCH OR DEVELOPMENT

None.

### REFERENCE TO A SEQUENCE LISTING, A TABLE, OR A COMPUTER LISTING COMPACT DISC APPENDIX

None.

### BACKGROUND OF THE INVENTION

This invention relates to a device and method of simulation and teaching, more specifically to a device and method that can be used in the medical field.

The perfect storm is approaching adult education in the workplace today. Many long standing and accepted approaches of teaching are being recognized as being outdated and inefficient for adult learning. Traditional teaching modalities such as standing in front of a group and reading slides for an hour have been shown to be highly inefficient and ineffective for learning. The apprentice method has been around for centuries, but this has been shown to be a dangerous way to learn in high-stakes industries. Millennials are the new learners in the workplace and they think and process information differently, consequently the older methods of passive learning are neither preferable nor suitable for training this segment of the population. It is well documented and widely accepted that active learning is much preferable to passive methodologies as it has a much higher success rate of both acquiring and retention of knowledge and skills. In our global world today with multinational companies and populations, the older methodologies of synchronous, collocated and passive teaching and learning are no longer suitable to teach these rapidly enlarging and diverse groups of learners that are also widely distributed geographically. Thus the storm is brewing!

In 1997 Clayton Christensen introduced the terms disruptive and sustaining innovation in his landmark book The Innovator's Dilemma, and he emphasized that it is imperative to have both to be successful! Sustaining innovation is defined as improving existing processes, but that without any disruptive changes over time, you start to see reduced efficiency. Adult education in the workplace as we know it today has become inefficient and is ripe for disruptive changes!

### SUMMARY OF THE INVENTION

This proposed invention satisfies the above needs.

A method that comprises establishing at least one computing device and an augmented reality environment wherein the augmented reality environment is comprised of a virtual space and a real space in which a participant is physically located and wherein at least one computing device comprises a method of processing natural language. The method may provide a participant with interaction comprising at least one computing device, an augmented reality environment or virtual reality environment, and feedback provided by at least one reviewer or at least one machine. The reviewer may be a teacher, professor, or other physical bystander person capable of providing feedback to the participant. The machine may be a programmed machine capable of reviewing or recording participant's input and providing feedback to the participant.

The computing device may be located locally or remotely through cloud computing. The augmented reality environment or virtual reality environment may comprise at least one head mounted display, a mobile device, a wireless connection to a computing device, a video display, devices for virtual interaction, a virtual space, and a real space.

The method may further comprise of a method of processing natural language in which an input sentence is processed by using an example of an actual use of a language most similar to the input sentence, said apparatus comprising input means for inputting an input sentence; conversion means for converting said input sentence into input sentence data; example storage means for storing a plurality of examples of actual uses of a language; selection means for calculating a degree of similarity between the input sentence data and each of the examples stored in said example storage means and for selecting an example corresponding to a highest degree of similarity wherein said selection means is further configured to calculate the degree of similarity by weighting some of the examples, said weighting being performed based on a context according to at least one of the examples previously selected; an output means whereby an output sentence is communicated to the participant. An input sentence or output sentence may be auditory, physical or virtual action.

The input sentence and apparatus output sentence may be stored within a computing device to be accessed locally or remotely. The participant may respond to an output sentence with a new input sentence.

A method of educating comprising establishing at least one computing device and an augmented reality environment wherein the augmented reality environment is comprised of a virtual space and a real space in which a student is physically located and wherein at least one computing device comprises a method of processing natural language. The method of educating further providing at least one student with interaction comprising at least one computing device, an augmented reality environment or virtual reality environment, and feedback provided by at least one instructor or at least one machine.

The method of educating wherein the computing device is located locally or remotely through cloud computing and wherein the augmented reality environment or virtual reality environment may comprise at least one head mounted display, a mobile device, a wireless connection to a computing device, a video display, devices for virtual interaction, a virtual space, and a real space.

The method of educating may further comprise of a method of processing natural language in which an input sentence is processed by using an example of an actual use of a language most similar to the input sentence, said apparatus comprising input means for inputting an input sentence; conversion means for converting said input sentence into input sentence data; example storage means for storing a plurality of examples of actual uses of a language; selection means for calculating a degree of similarity between the input sentence data and each of the examples stored in said example storage means and for selecting an example corresponding to a highest degree of similarity wherein said selection means is further configured to calculate the degree of similarity by weighting some of the examples, said weighting being performed based on a context according to at least one of the examples previously selected; an output means whereby an output sentence is communicated to the participant. An input sentence or output sentence may be auditory or physical action.

The student input sentence and apparatus output sentence may be stored within a computing device to be accessed locally or remotely. The student may respond to an output sentence with a new input sentence. The student may continue to respond to an output sentence with a new input sentence until a final output sentence is reached. The instructor may select an input sentence and the student is scored determinative on degree of similarity of the student's input sentence to the instructor's selected input sentence.

A method comprising at least one apparatus that transmits, during execution of a simulation application, a plurality of information over a network to at least one other apparatus worn by a different participant to ensure that the virtual avatar is simultaneously or near simultaneously seen by the plurality of participants in the augmented reality environment and appears similarly at any given time to the plurality of participants as if it were a physical object that the plurality of participants were to be able to simultaneously view in the same physical space, enabling a coordinated view of at least one virtual avatar wherein at least one apparatus is capable of processing natural language input by participant. The method wherein the plurality of information transmitted about a virtual avatar is comprised of location data, properties regarding the identity of the virtual avatar, properties regarding the effect of the virtual avatar on the other virtual avatars, properties regarding the physical object that virtual avatar resembles, or appearance data. The method wherein the virtual avatar responds to input by participant with programmed responses depending on the degree of similarity of participant's input to programmed natural language inputs. The method wherein the participant is scored determinative on participant's inputs and the network's programmed responses generated.

This application describes a unique teaching and learning methodology created by the merger and integration of both well accepted and emerging technologies in an effort to improve adult education. Current adult learning methodologies in the workforce today have become outdated and inefficient and are in need of disruption and replacement. Experiential or simulation learning with proximal feedback is becoming accepted as one of the best new modalities for adult learning, and this learning experience today is traditionally delivered on a physical platform and environment. This proposed model incorporates the transfer of the simulation learning experience from the current physical platform onto a virtual platform, and then integrates that with the new technologies of augmented reality, natural language processing and artificial intelligence. Augmented reality allows the learners to use their own actual physical environments with the added benefit of virtual components, thus inducing improved learning at a lower cost. Integration of natural language processing allows learners to learn and practice exactly as they will in real life by using verbal communication integrated into the simulation learning experience. The artificial intelligence (A.I) and automated algorithms of the natural language processing will allow for the proximal feedback in real time, reducing costs of one-to-one instructors. This integrated model will provide multiple advantages including improving training costs, allowing for the ability to inexpensively scale to massive non-collocated populations, and the standardization of learning experiences (critical in healthcare). It will also allow for learners to repeat the learning experiences as often as they need for better understanding and retention, or to use for just in time training, all on their own time schedule and at no extra cost. This unique combination and integration of both well validated simulation learning with the emerging technologies of augmented reality and natural language processing could begin the disruption and change that is needed today in adult education.

The first premise of this application is to transfer one of the best new learning modalities known today, immersive simulation training, from a physical platform to a digital platform, retaining all its learning capabilities while resolving some of its disadvantages. The second premise is to take this well-established methodology of training that has been moved on to a digital platform, and then integrate it into the new and emerging technologies of augmented reality and natural language processing.

The proposed combination of a simulation learning program onto a digital or virtual platform, accompanied by the integration of augmented reality and natural language processing, allows for a methodology of training and evaluation in real time at a level beyond any physical learning simulation programs existing today. Most importantly it allows for the use of natural language communication in learning events, exactly as is used in real life events. It allows for the total standardization of that training, which is the essence of error prevention in high reliability organizations. This model of learning easily scales to large groups of learners at very minimal cost (additional servers). When implemented it will be much more cost effective learning with significant ROI than any current learning model that presently exists. Although this learning program is originally being designed for healthcare, this instructional design of the combination of learning technologies could potentially be used for any type of immersive or simulation training in any industry. To this point this combination and integration of these existing and emerging technologies have never been combined and integrated for learning or teaching purposes, thus this design of the unique combination and integration of both well established and emerging technologies for teaching and immersive learning is unique.

Simulation Learning. Simulation training has been used in a few industries for years, but today many industries and fields, including healthcare, are now starting to adopt its use for improving training and learning. High-stakes industries that require high reliability organizations, i.e., those required to have extremely low error rates, either already have or are in the process of moving to simulation or experiential training of their employees. Industries such as aviation, nuclear power, and the military have used simulation training for years, and recently healthcare has embraced it as well. Another advantage of utilizing simulation training is the ability to obtain metrics on evaluation of that acquisition and retention of knowledge or skills. With standardization of training simulations benchmarking can now be used to assess learners' performances as well as their outcomes as a result of their learning experiences. Immersive simulation training with proximal feedback is widely recognized as one of the, if not the, most powerful learning modalities utilized today.

While simulation instruction is recognized as being optimal for learning and assessing tasks, procedures and processes that are performed manually, it still remains challenging to teach and assess cognitive processes and critical decision-making skills of learners. These challenges also extend to the evaluations and learning metrics in team training events. Presently these assessments are usually obtained manually, introducing increased subjectivity and variation, which significantly increases the potential for errors. The addition of newer and innovative technology offers us more standardization as solutions to meet these challenges.

Presently, immersive simulation learning is delivered on a physical platform. Training involves the use of physical task trainers or simulators, physical mannequins, manual evaluations of learning, highly trained faculty and adequate physical space to conduct simulation training. So while today simulation training is the optimal way to learn, this current learning methodology does have its shortcomings. Simulators, trainers and mannequins are expensive and have to be purchased and kept in good repair, and still often have to be replaced every few years. It often requires development and construction of various type of simulators for different types of skills or training, leading to increased costs. Trainers and simulators frequently become outdated requiring the purchase of newer versions and models. Training on a physically based platform needs to be synchronous, which means all learners have to be concurrently collocated, with resultant increased costs from both travel and loss of productivity.

So although simulation learning is the best methodology we have for adult learning today, there is still room for improvement. The first premise of this application is to transfer immersive simulation training from a physical platform to a digital or virtual platform, retaining all its optimal learning capabilities while resolving some of its disadvantages.

Virtual and Augmented Reality. The use of virtual reality (VR) has become immensely popular over the last few years as a result of the development of the Oculus Rift by Palmer Luckey and its subsequent acquisition by Facebook. Numerous other companies have rushed to also produce virtual reality programs that are delivered on head mounted displays (HMD), and this field has already become very crowded. These HDMs deliver for viewing a total immersive virtual environment, either by building an entire virtual world with computer programming or by utilizing immersive 360 photography. Most of the VR programs thus far have been built for gaming, but other areas such as sales, planning and even education are beginning to use VR. Many industries already have educational programs which utilize a VR platform, some of which have been around for years (e.g., aviation, military). However, to develop these total virtual worlds the entire environment has to be programmed, maintained, and reprogrammed as needed, usually at significant cost, which is one of the disadvantages of VR.

Augmented reality (AR), sometimes described as mixed reality, is a newer but also rapidly growing technology today. This involves the placement of an artificial virtual object into the actual physical world, thus continuing to allow the use of learners' own actual environments. Typically these types of AR programs have been used to place labels or information on physical objects in the actual world, such as addresses or information. There are at least three types of devices today that can be used for AR. The first is with a HMD similar to what is used with VR, but with which the viewer can see through and view the actual surrounding physical environment. It projects a virtual object into the own actual physical surroundings so the viewer uses the object superimposed on the actual view. Google glasses-like structures with added capabilities of AR (e.g, Google Glass) are also devices in this category. Likewise the new Hololens by Microsoft also fits into this category. A second type of AR is video see through, where a virtual object or person can be inserted into real life video (video see through) that is viewed through a HMD. The third type of AR is called spatial projection where it projects a volumetric display into the environment without the use of goggles or HMD. In addition, these AR insertions into the real world can also be used by mobile devices with the appropriate phone app or mobile application, when viewing through the camera lens of a mobile device the AR objects are inserted into the view of the physical environment (e.g., Pokeman Go.) This proposed technology can be utilized by any of these types of AR devices, depending on the user's needs and budget.

These technologies are not only cheaper to program than total VR environments, but also will allow learners to practice in their own physical surroundings with which they are already familiar. When the learner has the ability to practice in their own familiar work environment, this increases the effectiveness of the educational learning experience. Examples of training could be in the learners' own emergency department in an empty ED room, where a physician (wearing an AR device such as glasses or an optical head mounted device) has to care for an AR projected trauma patient on the ED table, or one in cardiac arrest. The learner has to diagnosis the problem from the patient's (virtual) appearance, the projected lab values and the projected physiological monitoring on the monitor. If the patient is in distress then tests and procedures will need to be immediately ordered (verbally), followed by the administration of appropriate medicines or procedures. Additionally, the AR virtual patient's parameters and appearance will change appropriately in response to the treatments ordered, just as is done in a physical simulation with a mannequin in a simulation training center.

Likewise, this type of training could be used in offices or clinics requiring only a programmed AR device. Since this methodology of simulation training can be performed anywhere, potentially even with learners non-collocated, it will scale easily to large numbers of learners by requiring only the addition of more servers. An added advantage is that with large numbers of trainees learning this way from a standardized environment and curriculum, their performance data can be aggregated and each learner compared to others, allowing benchmarking of a learner's skills. This is the second premise of this application, the concept of taking simulation learning and integrating and delivering it using an augmented reality platform.

Natural Language Processing. Presently when traditional teaching (lectures, materials, etc.) is attempted using virtual reality, it is usually on a computer monitor in a total virtual environment. The learner is usually requested to click icons to select multiple choice questions to determine their answers or the amount of learning or knowledge acquisition. This type of training of learners is a false representation as to what normally occurs in real life. For instance, in the real world in a rapidly progressing team or critical decision making event, essentially all communication is verbal or auditory. Simulation events are supposed to be as realistic as possible for the “suspension of disbelief”, which is where optimal learning occurs in simulation training. Interrupting the flow in one of these types of critical decision-making events by stopping to manually select answers or decisions is contrary to the theory of simulation learning. Humans just don't normally communicate with each other and their teams by clicking boxes or icons on a computer. Optimally the interactions during simulation training should be by verbal communication, just as in a real life event, and the optimal evaluation of that learning process should be of the communication flow process and the cognitive decisions made.

Natural language processing (NLP) is a branch of artificial intelligence and is the combination of computer science, machine learning, artificial intelligence, and computational linguistics. NLP is a way for computers to understand, analyze, generate responses and derive meaning from natural human language in a smart and useful way, and currently major advances are being made in this field. Natural language processing has been around for a long time, but until recently it has been based on algorithms that were produced manually. This process is slow, fraught with errors, and does not scale to any appreciable degree. With the addition of machine learning and artificial intelligence, now algorithms can be developed automatically from text or speech. These advances are allowing significant progress to be made in the recognition, analysis, understanding, and even the generation of appropriate responses and metrics. With learning events such as are being described here, the software program will be programmed to recognize certain words and phrases, such as the correct drug or dosage, and the correct route of administration . . . all in the correct order. Likewise it can be programmed to recognize incorrect responses which could result in the (virtual) patient's deterioration. Using IFTTT algorithms throughout the progression of the learning process (e.g., a code arrest with cardio-pulmonary resuscitation), a specific instruction will result in a specific result or change. Using this approach A.I. can now provide the ability to evaluate the level of cognitive learning and critical decision-making of a learner. It can also collect, aggregate and assess data from the more natural way a provider usually communicates with members of their team, verbally. The value of using NLP is that the more it is used and corrected, the more powerful and accurate it becomes! This is the third premise of the patent application; to integrate natural language processing into both the training and evaluation process so that the sequence of events flow much more realistically, leading to greatly improved learning while concurrently allowing for objective assessments of that learning.

If in the event a physical task is ever required to be performed during the learning event (e.g., chest compression, intubation, etc.) there are already existing haptic devices that can be utilized to measure the parameters from the actions of the learner and transfer them into the virtual scenario via Bluetooth. This input and parameters would be additive to and integrated into the data generated by natural language processing.

In one embodiment, to begin a training or learning session, the learner would go to the actual physical environment in which the learner wishes to use the acquired skills, e.g., an operating room or a hospital room, with all the surroundings and equipment that are familiar to the learner. The other components required in the room include the hardware device required for AR, i.e., either a head mounted display (HMD), AR equipped glasses, a mobile device with AR apps or a spatial projector. There are also some AR hardware equipment and software that are responsible for the projection of the virtual objects into the physical environment, and this will be connected to a cloud based server and integrated with the natural language processing software (NLP.)

The simulation scenario or exercise begins with the learner putting on either the AR glasses or the HMD and viewing the physical scene with the AR projections in it, or viewing the simulation training scenario through a mobile device and an AR app. Then the learner may see a virtual patient seated or lying on the physical bed in the room bed, or on the ground in an emergency scenario in the field for first responder training. Other accessory objects can be projected into the scenario as well, such as a family member or another provider, or readings on a monitor, or lab or imaging data. The learner visually assesses the virtual patient and any patient data provided, verbally communicates appropriately with any other people in the scenario, and starts verbalizing orders or directions in order to treat or improve the patient.

The learner's initial verbal comments or instructions trigger several events. Voice recognition software begins to transfer the spoken instructions and/or comments of the learner into the NLP software for initial analysis for assessments by algorithms using A.I. The software has keyword algorithms embedded in it for responses to correct diagnoses, medications and dosage, etc., but also will have algorithm responses for incorrect choices. Once the NLP program receives the data it will then analyze it and produce real-time responses to the learner's initial verbal directions. This may be in the form of an automated response from a nurse stating these orders have been completed, or if any labs or other (e.g. x-rays, CT scans) tests results were requested then those results will also be displayed. Simultaneously with those changes the virtual patient and AR data originally projected will also change according to the effects resulting from the learner's instructions, e.g., the assistant was instructed to turn the patient over, or a change in blood pressure resulting from the prescribed medication.

After the learner sees all the responses to the initial request or directions resulting in a change in the clinical condition of the patient and physiological parameters, the learner will verbalize the next set of comments and directions to address the new clinical presentation. As the simulation exercise proceeds, next steps will include the making of critical thinking decisions, requests for further diagnostic methods, the administration of medicines or a task or a manual event such as to start an IV or initiate chest compression. Each of these verbal instructions (e.g., type of medicine ordered to be given, the absence of a required step that would cause the patient to deteriorate) would trigger a new set of changes or events in the virtual patient's condition.

These first three steps; 1) the virtual presentation of a virtual problem patient in a real environment, 2) the learners' analysis and critical thinking decisions leading to verbal directions on actions to address the issues, and 3) the changes in the virtual situation and patient condition produced by the learner's directions; are the three major steps which are repeated until the end objectives of the training scenario are met. In the event of a high-stakes testing or final exam, it would conclude in the event of the learner passing or failing the testing scenario.

In another embodiment, every time a new or changed simulation event or scenario is presented to the learner, as a learning tool there will also be the option for the learner to access brief learning resources within the scene via AR. A request by the learner to visualize those resources would trigger a temporary pause in the training (pausing of the AR projections and action) while the learner reviews those resources. Exceptions to this would be in a rapidly moving or critical event, such as a patient bleeding profusely, or in the event of an examination simulation in which no access to resources would be available.

In another embodiment, at the conclusion of a simulation learning session in the physical world, the student joins an interactive debriefing session with a facilitator or debriefer how engages the learned in an interactive discussion of the event, which is called proximal feedback and is an essential part of interactive learning. When the simulation learning event is performed on a virtual platform, a synopsis of the learner's performance will be provided in real time. The natural language processing software will be able to understand questions from the learners and will develop algorithms for responses. This provides a written report of the learner's performance with appropriate learning resources in addition to an automated debriefing and interaction. This will include the learner having access to automated responses specific to any shortcomings or errors made during the simulation experience. This will be a particularly unique functionality of the program in that the proximal feedback will be automated and provided in real time following the virtual simulation experience. This is the benefit of A.I. in the program in that the more the program is used, the more it “learns” and then the more robust it becomes in assessing learners' performances and debriefing them.

### EXAMPLE 1

Cardiac Arrest in an ICU Room. A trained but inexperienced critical care specialist physician is starting her shift in the critical care unit at her hospital. It is a fairly quiet evening and there are several empty rooms in the unit. The physician doesn't feel totally comfortable running a code arrest response by herself at the hospital or in the critical care unit, and feels she needs to practice. She goes into one of the unoccupied critical rooms where the AR equipment is set up. She turns the equipment on and selects the program for advanced cardiac life support response on a patient who has undergone cardiac arrest and is not breathing. She puts on the AR glasses and turns on the scenario.

She suddenly sees a virtual patient in the physical bed in the room where she is, and hears a nurse's voice telling her the patient is not breathing and has no heartbeat. She immediately orders a nurse to start performing chest compressions, a code blue to be called overhead and for the code cart to be brought to the room. She calls for someone else to bring a bag valve mask (Ambu) bag to the room and to begin external ventilation. Meanwhile she is viewing the projected virtual EKG tracing on the monitor trying to diagnose the patient's arrhythmia. After the code court appears and chest compressions have begun, she sees the patient has converted to atrial fibrillation, and orders cardioversion (shocking) of the patient. She sees the electrodes applied and she dictates the parameters to be used (voltage, duration). She calls for the bed to be cleared and the cardioversion shock to be applied.

The patient responds to the cardioversion and the virtual heart rhythm on the monitor converts to a ventricular tachycardia. After reviewing the EKG and making the diagnosis, the physician orders amiodarone to be given intravenously and dictates the dosage, and after it is virtually injected the patient converts to a normal sinus rhythm. The patient seems to be settling down with a normal sinus rhythm (heartbeat) and is on nasal oxygen. At this point the physician student concludes the simulation as all the learning objectives have been met, and then will enter into an interactive discussion and debriefing with the AI and NLP of the program. Lastly the physician student receives a printed form assessing her performance along with points of discussion and references to resources for improvement if necessary.

### EXAMPLE 2

Arrival of an Obstetrical Patient in Early Labor. A newly graduated obstetrical (OB) nurse is working in labor and delivery at the hospital, and she had experienced some trouble on her first patient that turned out to be an emergency from vaginally bleeding. The patient survived and did well, but the nurse was now a little insecure about her care. A week later a call came in from the flight air evacuation crew that they were transporting a bleeding OB patient via helicopter. They would arrive in approximately 45 min, and the new nurse was the only one that could take the patient as everyone else was too busy. The nurse immediately went into an empty OB room there on the OB unit, and took with her the large tablet kept on the unit that had an AR program for OB hemorrhage on it. She turned the tablet on and opened the OB hemorrhage app. Looking though the camera, she turned it to the bed and saw a (virtual) bleeding OB lying in the bed, with her (virtual) husband standing beside the bed. The virtual husband said he was scared and was asking if his wife was going to be OK? At the same time a nursing assistant's (NA) virtual voice came from the tablet providing the patient's blood pressure and some data about the patient, then the NA asked the new nurse what she wanted to do next? A virtual timeclock appeared in the scene and she was notified she had 10 seconds to verbalize her orders as the patient was actively bleeding.

The nurse responded to the virtual patient's husband that they were going to take good care of his wife and that she should be fine. At the same time she ordered an IV be started, blood drawn for type and cross match for possible transfusion, and that an operating room be prepared. She also ordered that the patient be turned on her left side and a fetal monitor be placed on the patient to assess the baby status. Within a few seconds she saw the virtual fetal heart tracing of the baby projected which showed it to be stable. There was also a projection of a monitor that showed the patient's blood pressure had fallen to a critical level, well below the blood pressure of the patient when she (the nurse) had first entered the room. At this point she told the nursing assistant to call the patient's obstetrician stat, and to begin moving the patient back to the operating room. She requested the operating room team to be summoned to the operating room, and that the type and cross matched blood also be sent to the operating room. She again reassured the patient's virtual husband, who was panicking and asking rapid fire questions, that both his wife and the baby were having some problems and they were preparing for an emergency C-section for when the obstetrician arrived so the baby could be delivered. He seemed somewhat relieved and thanked her for all she was doing for his wife.

After the scenario ended she received a verbal message from the software program. It quickly debriefed her performance and said it was very good but it added two additional steps in an interactive discussion that she could have considered in addition to all of the steps she did take. She reviewed the suggested steps and asked two quick questions which were answered (AI) to her satisfaction. She then turned off the iPad and headed to the front door of the obstetrical unit to wait her new bleeding (live) patient coming in, certain now that she would now be able to skillfully manage the pregnant patient's condition and any complications.

### EXAMPLE 3

First Responder to a Motor Vehicle Accident. There have been significant changes and new recommendations in the recommended procedures for first responders in taking care of victims in the field. An older paramedic who is out of date on his certifications needed to review and practice these changes, and goes to an ambulance in their office parking lot for some virtual training. He dons the Google type AR glasses and turns the training program on. There on the ground beside the ambulance he sees a virtual young child lying there, who is unconscious, bleeding, and appears to have a broken leg. He tells his (virtual) partner to first check for breathing and a pulse at which time those physiological parameters pop up on a small virtual screen on his AR glasses. He then requests an IV be started and that EKG leads be placed on the patient. At that time the EKG tracing shows up on his AR glasses and appears to be normal but with severe tachycardia (rapid heartbeat). This could be evidence of internal bleeding and then he becomes much more concerned. He orders a splint be placed on the leg immediately, which is done to the virtual patient, and orders a heart slowing medicine to be admitted administered through the IV for the child. He orders the child be placed on a stretcher immediately and moved into the ambulance to be rapidly transported to the hospital.

As the virtual ambulance pulls away the scenario ends and the debriefing is provided to the learner by automated response by the NLP. The virtual child had some symptoms and visual evidence of a fractured cervical vertebra, which the learner missed, and by moving the child without a neck brace it caused some neurological damage which will leave the child permanently disabled. In addition, it warned that the administration of a heart slowing medicine without knowing the cause can be very dangerous. Tachycardia is the body's response to get more blood to the brain and slowing that without increasing IV fluids or determining the cause could cause hypoxia to the child's brain. Along with this interactive debriefing learning his questions were answered and then recommendations and resources were provided to him. It was recommended that he repeat the training scenario in the near future before taking care of any pediatric patients and in the meantime to pursue formal re-certification.

### REFERENCES

1. Christensen C M. The innovator's dilemma: when new technologies cause great firms to fail. Boston (Mass.): Harvard Business School Press; 1997.
2. McGaghie W C, Issenberg S B, Barsuk J H, Wayne D B. A critical review of simulation-based mastery learning with translational outcomes. Med Educ 2014; 48:375-85.
3. Cass S, Choi C Q. Google Glass, Halolens, and the real future of augmented reality. IEEE Spectrum 2015. Available at: http://spectrum.ieee.org/consumer-electronics/audiovideo/google-glass-hololens-and-the-real-future-of-augmented-reality. Retrieved Nov. 27, 2015.
4. Hirschberg J., Manning C., Advances in Natural Language Processing, Science, vol 349, 2015
5. Thornberg D. From the campfire to the holodeck: creating engaging and powerful 21st century learning environments. San Francisco (Calif.): Jossey-Bass; 2014

### BRIEF DESCRIPTION OF THE DRAWINGS

These and other features, aspects, and advantages of the present invention will become better understood with regard to the following descriptions, appended claims, and accompanying drawings where:

FIG. 1 shows one embodiment of the claimed invention in which a virtual reality scenario is depicted.

FIG. 2 shows one embodiment of the claimed invention in which an augmented reality medical training scenario is depicted.

FIG. 3 shows one embodiment of the claimed invention in which an augmented reality medical practice scenario is depicted.

FIG. 4 depicts a flow diagram of one embodiment of the claimed invention

### DETAILED DESCRIPTION OF THE INVENTION

In the Summary of the Invention above and in the Detailed Description of the Invention, and the claims below, and in the accompanying drawings, reference is made to particular features of the invention. It is to be understood that the disclosure of the invention in this specification includes all possible combinations of such particular features. For example, where a particular feature is disclosed in the context of a particular aspect or embodiment of the invention, or a particular claim, that feature can also be used, to the extent possible, in combination with and/or in the context of other particular aspects and embodiments of the invention, and in the invention generally.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit, and scope of the invention. All such similar substitutes and modifications apparent to those skilled in the art are deemed to be within the spirit, scope, and concept of the invention as defined by the appended claims.

The term “comprises” and grammatical equivalents thereof are used herein to mean that other components, ingredients, steps, etc. are optionally present. For example, an article “comprising” (or “which comprises”) components A, B, and C can consist of (i.e., contain only) components A, B, and C, or can contain not only components A, B, and C but also one or more other components.

Where reference if made herein to a method comprising two or more defined steps, the defined steps can be carried out in any order or simultaneously (except where the context excludes that possibility), and the method can include one or more other steps which are carried out before any of the defined steps, between two of the defined steps, or after all the defined steps (except where the context excludes that possibility).

The term “at least” followed by a number is used herein to denote the start of a range beginning with that number (which may be a range having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%. When, in this specification, a range is given as “(a first number) to (a second number)” or “(a first number)-(a second number),” this means a range whose lower limit is the first number and whose upper limit is the second number. For example, 25 to 100 mm means a range whose lower limit is 25 mm, and whose upper limit is 100 mm.

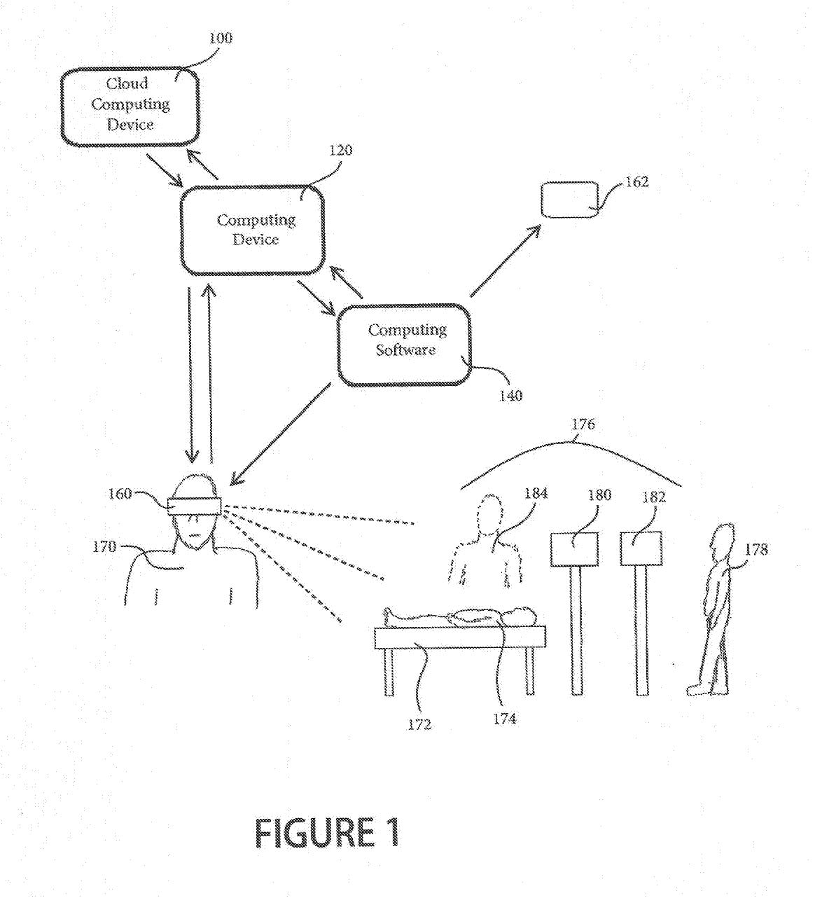

As shown in FIG. 1, one embodiment of the claimed method comprises a cloud computing device 100, a computing device 120, computing software 140, and a head mounted display 160. The cloud computing device 100 may be housed in a virtual location and transmitted via a wireless network to a computing device 120. The computing device 120 may contain software for processing natural language or artificial intelligence. The computing software 140 enables the computing device to interact with the head mounted display 160 and incorporate augmented reality or virtual reality into the head mounted display 160.

In one embodiment, there may be multiple displays 160 162 connected to the computing device 120 and incorporating the computing software 140. A monitor 162 may be used to project the virtual or augmented reality environment for viewing or interaction by persons outside of the virtual or augmented reality environment.

In one embodiment, the head mounted display 160 is worn by a learner 170. Projected within the head mounted display 160 is a virtual or augmented reality environment in which the learner 170 may participate. In a preferred embodiment, the head mounted display 160 utilizes a camera system to integrate the real environment into the display.

As shown in FIG. 1, a learner 160 may see through the head mounted display 160 a virtual patient 172 on a real hospital bed 174. In a specific embodiment, the learner 270 is a medical school student. The learner may also see virtual patient monitors 176 and other virtual or real persons 178 in the room. In one embodiment, the learner 170 inputs verbal or physical signals into the computing device 120 to be recognized and processed by natural language processing incorporating artificial intelligence. Once processed these signals are then read by the computing software 140. Determinative of processed input signal, the computing software 140 may then alter the virtual or augmented reality environment in which the learner 170 is participating. The learner 170 then sees the altered virtual or augmented reality environment through the head mounted display 160. Any combination of the environmental components may be altered, including but not limited to the virtual patient 172, the virtual patient monitors 176, and other virtual or real persons in the environment 178 284.

As shown in FIG. 1, in one embodiment, the virtual patient monitors 176 may include a time clock 180, a heart rate monitor 182, and any number of nurse avatars 184. In a preferred embodiment, the virtual patient monitors 176 are altered by the computing software 140 in real time determinative of learner 170 input.

In one embodiment, once the learner's 170 input is processed by the computing device 120 and an alteration is made in response by the computing software 140, the learner 170 may make another verbal or physical input to the environment, triggering another response and alteration to the environment by the computing software 140. In one embodiment, no response by the learner 170 to an alteration may trigger another alteration to the environment.

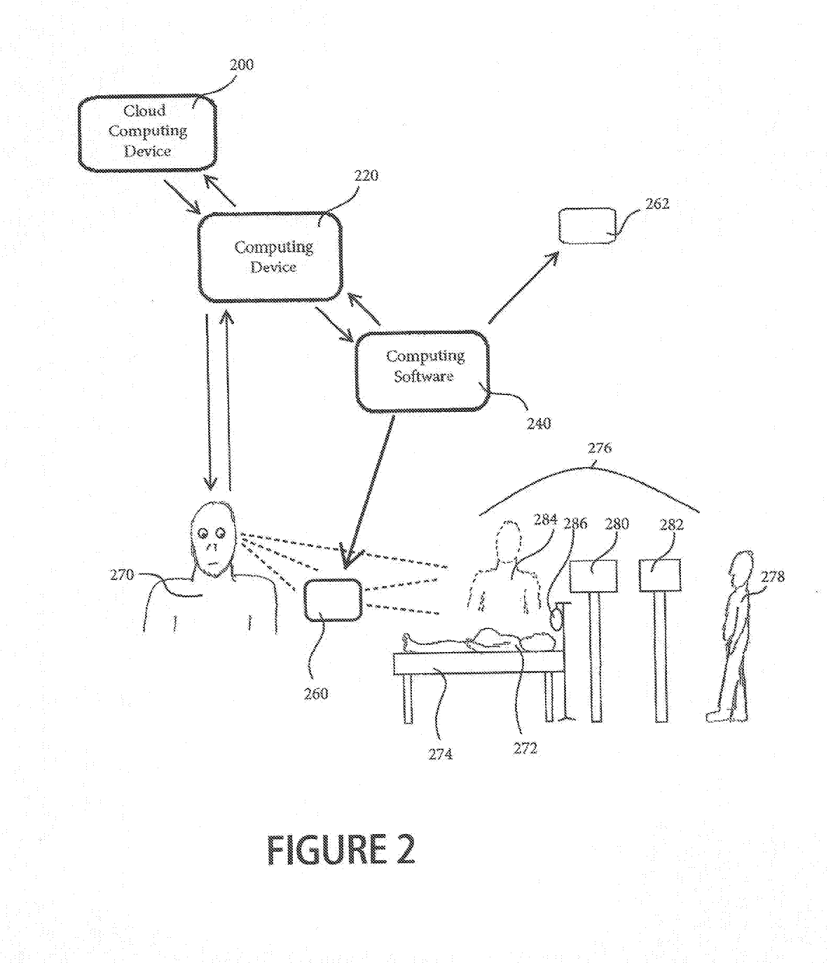

As shown in FIG. 2, one embodiment of the claimed method comprises a cloud computing device 200, a computing device 220, computing software 240, and a mobile device 260. The cloud computing device 200 may be housed in a virtual location and transmitted via a wireless network to a computing device 220. The computing device 220 may contain software for processing natural language or artificial intelligence. The computing software 240 enables the computing device to interact with the head mounted display 260 and incorporate augmented reality or virtual reality into the mobile device 260.

In one embodiment, there may be multiple displays 260 262 connected to the computing device 220 and incorporating the computing software 240. A monitor 262 may be used to project the virtual or augmented reality environment for viewing or interaction by persons outside of the virtual or augmented reality environment.

In one embodiment, the mobile device 260 is held by the learner 270. In one embodiment, the mobile device 260 is mounted within reach of the learner 270. In a preferred embodiment, the mobile device 260 is a display device with a camera that allows learner 270 interaction with an augmented reality or virtual reality environment.

As shown in FIG. 2, a learner 270 may view a scenario on a mobile device 260 in which virtual patient 272 is on a real hospital bed 274. In one embodiment, the learner 270 is a nurse. In one embodiment, the mobile device 260 will utilize a camera to view in real time the real hospital bed 274 and the computing software 240 will project the virtual patient 272 onto the real hospital 274 to be viewed by the learner 270 on the mobile device 260. The learner may also see virtual patient monitors 276 and other virtual or real persons 278 in the room. In one embodiment, the learner 270 inputs verbal or physical signals into the computing device 220 via the mobile device 260 to be recognized and processed by natural language processing incorporating artificial intelligence. Once processed these signals are then read by the computing software 240. Determinative of processed input signal, the computing software 240 may then alter the virtual or augmented reality environment in which the learner 270 is participating. The learner 270 then sees the altered virtual or augmented reality environment through the mobile device 260. Any combination of the environmental components may be altered, including but not limited to the virtual patient 272, the virtual patient monitors 276, and other virtual or real persons in the environment 278 284.

As shown in FIG. 2, in one embodiment, the virtual patient monitors 276 may include a time clock 280, a fetal monitor 282, an IV stand and readout 286, and any number of nurse avatars 284. In a preferred embodiment, the virtual patient monitors 276 are altered by the computing software 240 in real time determinative of learner 270 input.

In one embodiment, once the learner's 270 input is processed by the computing device 220 and an alteration is made in response by the computing software 240, the learner 270 may make another verbal or physical input to the environment, triggering another response and alteration to the environment by the computing software 240. In one embodiment, no response by the learner 270 to an alteration may trigger another alteration to the environment.

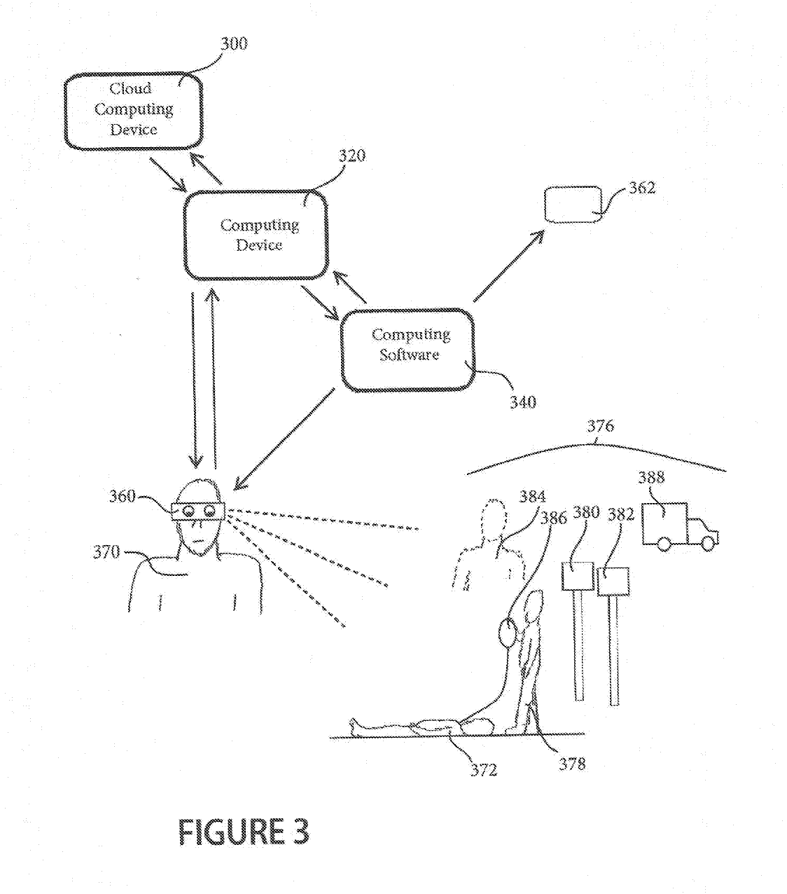

As shown in FIG. 3, one embodiment of the claimed method comprises a cloud computing device 300, a computing device 320, computing software 340, and a worn augmented display 360. The cloud computing device 300 may be housed in a virtual location and transmitted via a wireless network to a computing device 320. The computing device 320 may contain software for processing natural language or artificial intelligence. The computing software 340 enables the computing device to interact with the worn augmented display 360 and incorporate augmented reality or virtual reality into the worn augmented display 360.

In one embodiment, there may be multiple displays 360 362 connected to the computing device 320 and incorporating the computing software 340. A monitor 362 may be used to project the virtual or augmented reality environment for viewing or interaction by persons outside of the virtual or augmented reality environment.

In one embodiment, the worn augmented display 360 is worn by a learner 370. Projected through the worn augmented display 360 is a virtual or augmented reality environment in which the learner 370 may participate. In a preferred embodiment, the worn augmented display 360 is transparent, allowing the learner 370 to view the real environment. The worn augmented display 360 projects virtual or augmented reality into the learner's 370 view.

As shown in FIG. 3, a learner 370 may see through the worn augmented display 360 a virtual patient 372 on the ground. In one embodiment, the learner 370 is a first responder. The learner may also see virtual patient monitors 376 and other virtual or real persons 378 in the environment. In one embodiment, the learner 370 inputs verbal or physical signals into the computing device 320 to be recognized and processed by natural language processing incorporating artificial intelligence. Once processed these signals are then read by the computing software 340. Determinative of processed input signal, the computing software 340 may then alter the virtual or augmented reality environment in which the learner 370 is participating. The learner 370 then sees the altered virtual or augmented reality environment through the worn augmented display 360. Any combination of the environmental components may be altered, including but not limited to the virtual patient 372, the virtual patient monitors 376, and other virtual or real persons in the environment 378 384.

As shown in FIG. 3, in one embodiment, the virtual patient monitors 376 may include a time clock 380, a heart rate monitor 382, any number of nurse avatars 384, an IV stand and readout 386, and an ambulance 388. In a preferred embodiment, the virtual patient monitors 376 are altered by the computing software 340 in real time determinative of learner 370 input.

In one embodiment, once the learner's 370 input is processed by the computing device 320 and an alteration is made in response by the computing software 340, the learner 370 may make another verbal or physical input to the environment, triggering another response and alteration to the environment by the computing software 340. In one embodiment, no response by the learner 370 to an alteration may trigger another alteration to the environment.

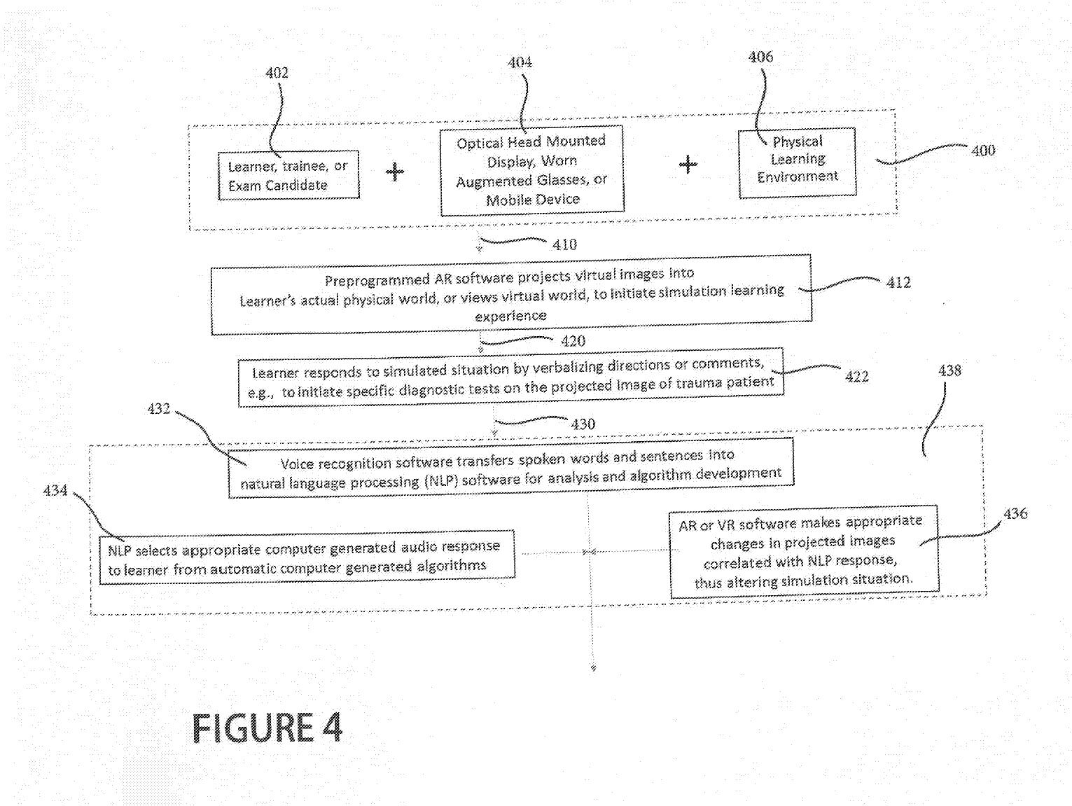

As depicted in FIGS. 4A-4B, one embodiment of the claimed method comprises an augmented reality or virtual reality environment 400 comprised of at least a learner 402, a display device 404, and a physical learning environment 404. In one embodiment, the learner 402 may be a student, trainee, or exam candidate. In one embodiment, the display device 404 may be an optical head mounted display, worn augmented glasses, or a mobile device.

As further shown in FIGS. 4A-4B, the augmented reality or virtual reality environment 400 interacts 410 with software 412 to create an augmented reality environment in which virtual images are projected into the physical world to initiate a simulation learning experience. The interaction 410 of the augmented reality or virtual reality environment 400 with the software 412 may be wired, remote, or cloud based. In one embodiment, the software 412 then communicates 420 with the learner 402 through a display device 404. A learner input response 422 is then generated determinative of the augmented reality or virtual reality environment 400 communicated 420 with the learner. In one embodiment, references and real-time feedback are given to learner 402 in the augmented reality or virtual reality environment 400 if the simulation is a learning experience. In another embodiment, references and real-time feedback are not given to learner 402 in the augmented reality or virtual reality environment 400 if the simulation is an examination to test the learner's performance.

The learner input response 422 may be communicated 430 audibly or physically. In one embodiment, the learner input response 422 may be no response. The learner input response 422 is received by software 432 that then processes the input. In one embodiment, the audible learner input response 422 is processed by natural language processing software 432. In another embodiment, the physical learner input response 422 may be processed. In yet another embodiment, a reviewer may receive the learner input response 422.

As depicted in FIGS. 4A-4B, in one embodiment, the natural language processing software 432 generates a response 424 determinative of the learner input response 422. The software 412 is then directed 436 based on the response 434 to change the augmented reality or virtual reality environment 400, thus altering the simulation situation for the learner 402. The process of the learner input response 422 and the natural language processing response 432 434 to direct 436 an alteration to the augmented reality or virtual reality environment 400 may repeat 438. In one embodiment, this repetition 438 may continue until the correct learner input response 422 is achieved. In another embodiment, this repetition 438 may terminate if the incorrect learner input response 422 is received. In one embodiment, references and real-time feedback are given to learner 402 in the augmented reality or virtual reality environment 400 if the simulation is a learning experience. In another embodiment, references and real-time feedback are not given to learner 402 in the augmented reality or virtual reality environment 400 if the simulation is an examination to test the learner's performance.

In one embodiment, the learner 402 responses, directions, answers, and critical thinking decisions are analyzed by natural language processing, machine learning, or a reviewer. Then, debriefing audio interactive questions may be generated to learner 402. Learner 402 again responds with learner input response 422 which is further analyzed by software 434 that can then generate further interactive questions as appropriate for learner. Once a scenario has been completely debriefed, learners are provided a synopsis of their level of success at the simulation exercise, both by auto-generated language as well as text based documentation. This is accompanied by a list of evidence based support of each decision point, as well as suggestions for improvement and a list of resources. During this debriefing, the learner can respond to generated questions from the program as well as ask questions to the software with automated answers in an interactive exchange and discussion. In another embodiment, in the case of summative evaluation or final testing, no debriefing is performed and a pass/fail designation is determined and reported.

What is claimed is:

1. A method comprising:
Establishing at least one computing device and an augmented reality environment;
Wherein the augmented reality environment is comprised of a virtual space and a real space in which a participant is physically located;
Wherein at least one computing device comprises a method of processing natural language;
Providing participant with interaction comprising at least one computing device, an augmented reality environment or virtual reality environment, and feedback provided by at least one reviewer or at least one machine.

2. The method of claim 1 wherein the computing device is located locally or remotely through cloud computing.

3. The method of claim 1 wherein the augmented reality environment or virtual reality environment may comprise at least one head mounted display, a mobile device, a wireless connection to a computing device, a video display, devices for virtual interaction, a virtual space, and a real space.

4. The method of claim 1 wherein the method of processing natural language in which an input sentence is processed by using an example of an actual use of a language most similar to the input sentence, said apparatus comprising:
Input means for inputting an input sentence;
Conversion means for converting said input sentence into input sentence data;
Example storage means for storing a plurality of examples of actual uses of a language;
Selection means for calculating a degree of similarity between the input sentence data and each of the examples stored in said example storage means and for selecting an example corresponding to a highest degree of similarity
Wherein said selection means is further configured to calculate the degree of similarity by weighting some of the examples, said weighting being performed based on a context according to at least one of the examples previously selected; and
Output means whereby an output sentence is communicated to the participant.

5. The method of claim 4 wherein the participant input sentence and apparatus output sentence are stored within the computing device and can be accessed locally or remotely.

6. The method of claim 4 wherein the participant responds to said output sentence with a new input sentence.

7. A method of educating comprising:
Establishing at least one computing device and an augmented reality environment;
Wherein the augmented reality environment is comprised of a virtual space and a real space in which a student is physically located;
Wherein at least one computing device comprises a method of processing natural language;
Providing student with interaction comprising at least one computing device, an augmented reality environment or virtual reality environment, and feedback provided by at least one instructor or at least one machine.

8. The method of claim 7 wherein the computing device is located locally or remotely through cloud computing.

9. The method of claim 7 wherein the augmented reality environment or virtual reality environment may comprise at least one head mounted display, a mobile device, a wireless connection to a computing device, a video display, devices for virtual interaction, a virtual space, and a real space.

10. The method of claim 7 wherein the method of processing natural language in which an input sentence is processed by using an example of an actual use of a language most similar to the input sentence, said apparatus comprising:
Input means for inputting an input sentence;
Conversion means for converting said input sentence into input sentence data;
Example storage means for storing a plurality of examples of actual uses of a language;
Selection means for calculating a degree of similarity between the input sentence data and each of the examples stored in said example storage means and for selecting an example corresponding to a highest degree of similarity
Wherein said selection means is further configured to calculate the degree of similarity by weighting some of the examples, said weighting being performed based on a context according to at least one of the examples previously selected; and
Output means whereby an output sentence is communicated to the student.

11. The method of claim 10 wherein the student input and apparatus output are stored within the computing device and can be accessed locally or remotely.

12. The method of claim 10 wherein the student responds to said output sentence with a new input sentence.

13. The method of claim 12 wherein the student responds to said output sentence with a new input sentence until a final output sentence is reached.

14. The method of claim 10 wherein the instructor selects an input sentence and the student is scored determinative on degree of similarity of the student's input sentence to instructor's selected input sentence.

15. A method comprising at least one apparatus that transmits, during execution of a simulation application, a plurality of information over a network to at least one other apparatus worn by a different participant to ensure that the virtual avatar is simultaneously or near simultaneously seen by the plurality of participants in the augmented reality environment and appears similarly at any given time to the plurality of participants as if it were a physical object that the plurality of participants were to be able to simultaneously view in the same physical space, enabling a coordinated view of at least one virtual avatar wherein at least one apparatus is capable of processing natural language input by participant.

16. The method of claim 15, wherein the plurality of information transmitted about a virtual avatar is comprised of location data, properties regarding the identity of the virtual avatar, properties regarding the effect of the virtual avatar on the other virtual avatars, properties regarding the physical object that virtual avatar resembles, or appearance data.

17. The method of claim 15 wherein the virtual avatar responds to input by participant with programmed responses depending on the degree of similarity of participant's input to programmed natural language inputs.

18. The method of claim 15 wherein the participant is scored determinative on participant's inputs and the network's programmed responses generated.
